(19) United States
(12) Patent Application Publication
(10) Pub. No.: US 2026/0216589 A1
(43) Pub. Date: Jul. 30, 2026

(54) KIT FOR A FRAMED PUZZLE WITH LIGHTING THAT DISPLAYS DIFFERENT IMAGES

(71) Applicant: CLEMENTONI S.P.A., RECANATI (MC) (IT)

(72) Inventors: Francesco MORETTI, RECANATI (MC) (IT); Francesco GIUSTOZZI, OSIMO (AN) (IT)

(21) Appl. No.: 19/446,388

(22) Filed: Jan. 12, 2026

(30) Foreign Application Priority Data
Jan. 24, 2025 (IT) 102025000001230

(51) Int. Cl. A63F 9/10; A47G 1/06; F21V 33/00; F21Y 113/13

(52) U.S. Cl. CPC A63F 9/1044; A47G 1/0622; F21V 33/008; A63F 2009/1083; F21Y 2113/13

(57) ABSTRACT

A kit comprises a puzzle comprising a plurality of interlocking pieces, a frame suitable for supporting the puzzle, and a light source mounted in the frame and suitable for emitting a red, green and blue light. The pieces of the puzzle are obtained by cutting a die-cut whereon a first image of red color, a second image of green color and a third image of blue color are printed, which are respectively visible with a red, green and blue light.

### CROSS-REFERENCE TO RELATED APPLICATIONS

Not applicable.

### FIELD OF THE INVENTION

The present invention relates to the field of games and, in particular, to a puzzle kit made of pieces with a special print and provided with a particular type of lighting that displays different images reproduced on the puzzle obtained with said pieces.

### BACKGROUND OF THE INVENTION

As it is well known, a puzzle comprises a plurality of pieces having a perimeter profile that is suitably shaped in such a way to be uniquely interlocked with each other. Once completed, the puzzle reproduces a specific image. Generally speaking, the completed puzzle is framed and hung on a wall, just like a painting. Obviously, in such a case, the puzzle displays a single image.

JP2001252461A discloses a space-saving jigsaw puzzle.

Recently, the RGB art, which is also known as Carnovsky RGB art, has been gaining popularity. The RGB art can create an art installation with three different images layered one on top of the other. A colored filter made of a transparent material is arranged over the installation. The colors of the filter are red, green, and blue, and each color reveals one of the three layers of the installation. Therefore, depending on the color (red, green, or blue) of the light that illuminates the filter, the user will see the image of one of the three layers of the installation.

### SUMMARY OF THE INVENTION

The purpose of the present invention is to eliminate the drawbacks of the prior art by providing a kit for a framed puzzle that displays different images reproduced on the same puzzle.

Another purpose is to provide such a puzzle kit that is practical, versatile, and easy to use.

These purposes are achieved in accordance with the invention with the characteristics of the attached independent claim 1.

Advantageous embodiments of the invention appear from the dependent claims.

### BRIEF DESCRIPTION OF DRAWINGS

Further features of the invention will become clearer from the following detailed description that refers to a purely exemplary and therefore non-limiting embodiment which is illustrated in the accompanying drawings.

FIG. 1 is an exploded perspective view illustrating the various parts of the puzzle kit according to the invention.

FIG. 2 is a perspective view illustrating the parts of the kit of FIG. 1 in assembled condition, without the upper cover.

FIG. 3 is a sectional view taken along the section plane III-III of FIG. 1.

FIG. 4 is a sectional view taken along the section plane IV-IV of FIG. 1.

FIG. 5 is a top view of the assembled kit.

FIG. 6 is a perspective view illustrating a portion of the assembled kit, wherein the puzzle and its support have been omitted.

FIG. 7 is a bottom view of the assembled kit.

FIG. 8 is a plan view of a printed die-cut used to make the puzzle pieces of the kit according to the invention.

### DETAILED DESCRIPTION OF THE INVENTION

With the aid of the Figures, a puzzle kit according to the invention, which is generally indicated with reference numeral 100, is described.

The kit (100) comprises:

a puzzle (1) comprising a plurality of pieces (10) interlocked with each other;

a frame (2) suitable for supporting the puzzle (1); and

a light source (3) that is mounted in the frame (2) and is suitable for emitting a red, green, and blue light.

The kit (100) may comprise a support (4) suitable for supporting the puzzle (1) and fastening means (5) suitable for fastening the puzzle (1), the support (4), and the light source (3) to the frame (2).

The kit (100) may comprise a cover (6) suitable for covering the frame (2).

Although, for the sake of simplicity, the Figures show a straight perimeter profile of the pieces (10), evidently, the pieces (10) have a suitable perimeter profile in such a way to be uniquely interlocked with each other.

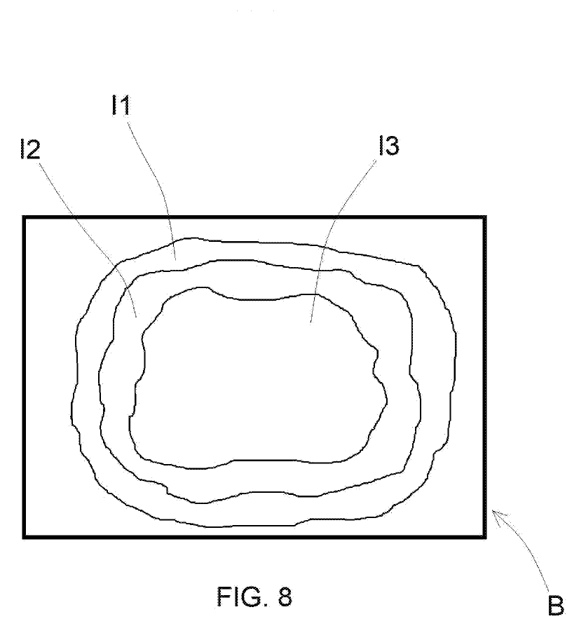

With reference to FIG. 8, the pieces (10) are obtained from a die-cut (B) generally made of cardboard.

Using a well-known printing technique, a first image (I1) in red, a second image (I2) in green, and a third image (I3) in blue are printed on the die-cut (B). The three images (I2, I2, I3) are different from each other and superimposed one on top of the other.

The colors of the three images (I1, I2, I3) are such that:

if the die-cut (B) is illuminated with a red light, only the first image (I1) is visible and the second and third images are not visible;

if the die-cut (B) is illuminated with a green light, only the second image (I2) is visible and the first and third images are not visible;

if the die-cut (B) is illuminated with a blue light, only the third image (I3) is visible and the first and second images are not visible.

In fact, the red/blue/green light spectrum acts as a filter on the images (I1, I2, I3) in such a way that only one of the three images is visible.

The die-cut (B) is cut with a cutting or die-cutting machine to obtain a plurality of pieces (10).

Each piece (10) has an upper surface (11) that comprises three portions of the three images (I1, I2, I3); otherwise said, the piece has a portion of the first image (I1) that is visible with a red light, a portion of the second image (I2) that is visible with a green light, and a portion of the third image (I3) that is visible with a blue light.

In view of the above, once the puzzle (1) has been completed, the image portions of each piece (10) will form a complete image. Therefore the puzzle (1) reproduces three different images (I1, I2, I3) that are superimposed one on top of the other, wherein the first image (I1) is visible with a red light, the second image (I2) is visible with a green light, and the third image (I3) is visible with a blue light.

The kit (100) may comprise a support (4) with a planar shape, for example like a rectangular plate, with four corner portions (40). The support (4) may be made of cardboard.

In view of the above, once completed, the puzzle (1) is disposed on the support (4). The kit (100) may comprise glue or adhesive that is spread on the support (4) in order to glue the puzzle (1) to the support (4).

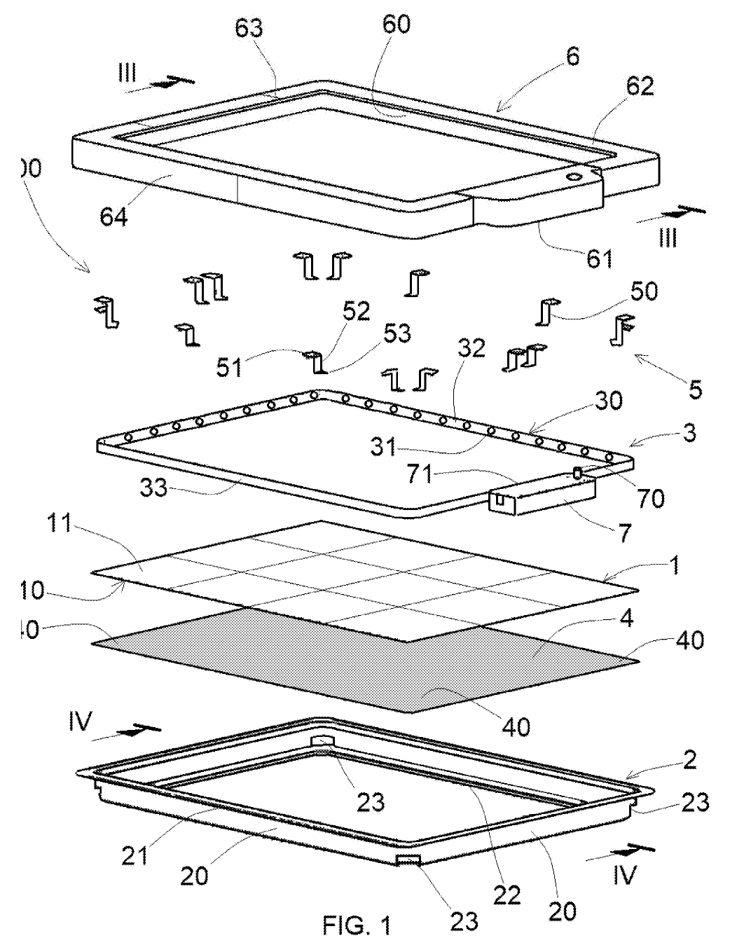

With reference to FIGS. 1 and 4, the frame (2) has a rectangular shape. The frame (2) comprises side walls (20) and an upper flange (21) that protrudes externally from an upper edge of the frame. The side walls (20) of the frame have an inward-facing housing (22). The housing (22) of the frame has an inverted U-shape in cross-section and extends across all the side walls of the frame. The frame comprises slots (23) formed at the corners between the side walls (20).

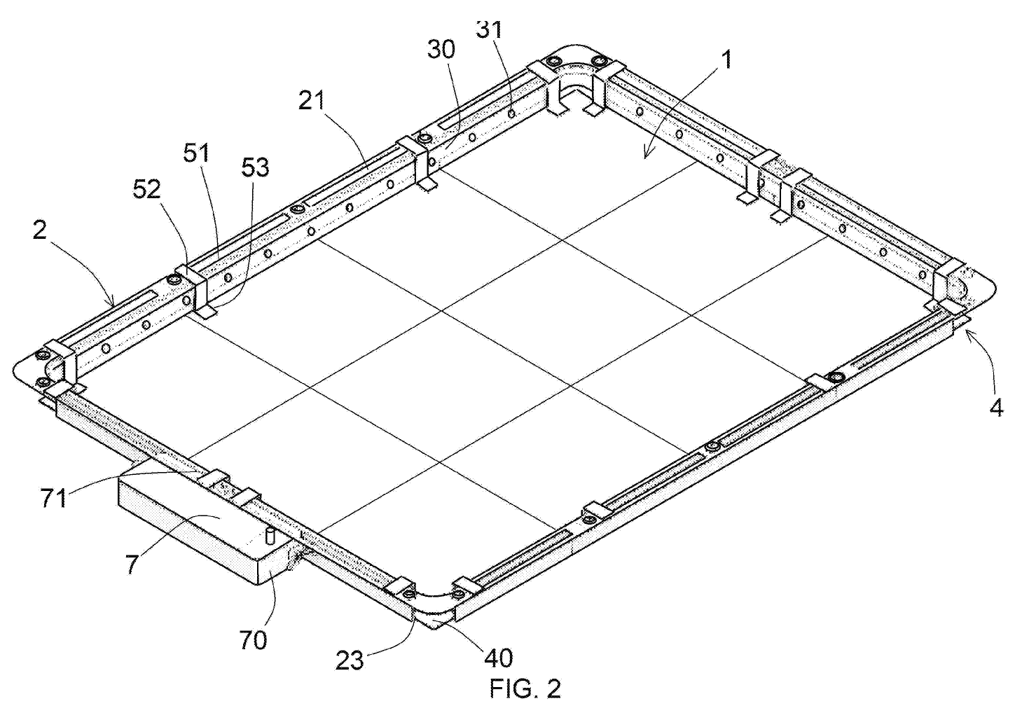

The support (4) has a perimeter such that the corner portions (40) of the support (4) are engaged in the slots (23) of the frame so as to securely fix the support (4) to the frame (2), as shown in FIG. 2.

The light source (3) comprises an RGB LED strip (30) comprising a plurality of LEDs (31) configured to emit a red, green, and blue light. By way of example, the RGB LED strip (30) may comprise 50-70 LEDs.

The RGB LED strip (30) has a length equal to the perimeter of the frame (2). In this way, the LED strip (30) can be bent like a rectangular element and inserted into the housing (22) of the frame.

The RGB LED strip (30) comprises a front side (32) whereon the LEDs (31) are mounted and an adhesive back side (33) that adheres to the housing (22) of the frame.

The RGB LED strip (30) is electrically connected to a power supply (7) suitable for electrically powering the LEDs (31).

The power supply (7) may comprise replaceable or rechargeable batteries and/or an electrical connector for connection to an electrical mains.

The power supply (7) comprises a button (70) that can be operated by the user. The button (70) protrudes superiorly from the power supply. The button (70) is configured to be operated by the user to enable four possible lighting modes:

a first mode, wherein the LEDs (31) are continuously powered to emit a red light;

a second mode, wherein the LEDs (31) are continuously powered to emit a green light;

a third mode, wherein the LEDs (31) are continuously powered to emit a blue light; and

a fourth mode, wherein the LEDs (31) are powered to respectively emit a red, green, and blue light alternately for a preset time.

The button (70) may be a push button or a knob.

The power supply (7) has the shape of a parallelepiped box that is connected to the LED strip by means of a connection (71) so as to protrude externally with respect to the RGB LED strip (30).

With reference to FIG. 2, when the RGB LED strip (30) is inserted into the housing (22) of the frame, the connection (71) of the power supply is disposed above the flange (21) of the frame and the power supply (7) protrudes externally from the frame (2).

The fastening means (5) may comprise clips (50) suitable for retaining the RGB LED strip (30) in the housing (22) of the frame and compress the puzzle (1) onto the support (4) fixed to the frame (2). For such a purpose, each clip (50) has a Z-shape comprising a central portion (51), an upper portion (52), and a lower portion (53).

In this way, as shown in FIG. 2, the upper portion (52) of the clip is hooked onto the flange (21) of the frame; the central portion (51) of the clip holds the RGB LED strip (30), and the lower portion (53) of the clip presses on the puzzle (1).

The cover (6) is suitable for being disposed on the frame (2) so as to cover the frame (2), the clips (50) applied to the frame (2), and the power supply (7).

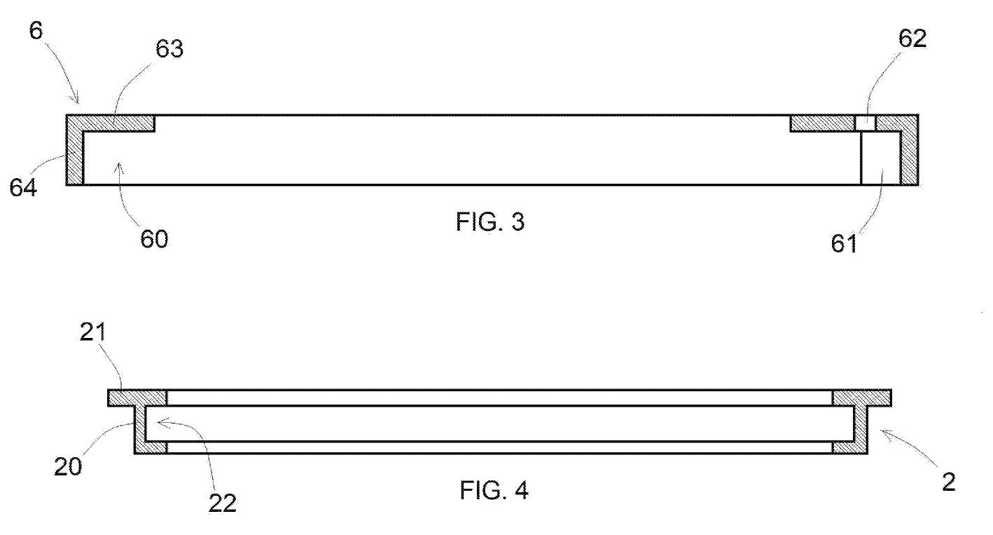

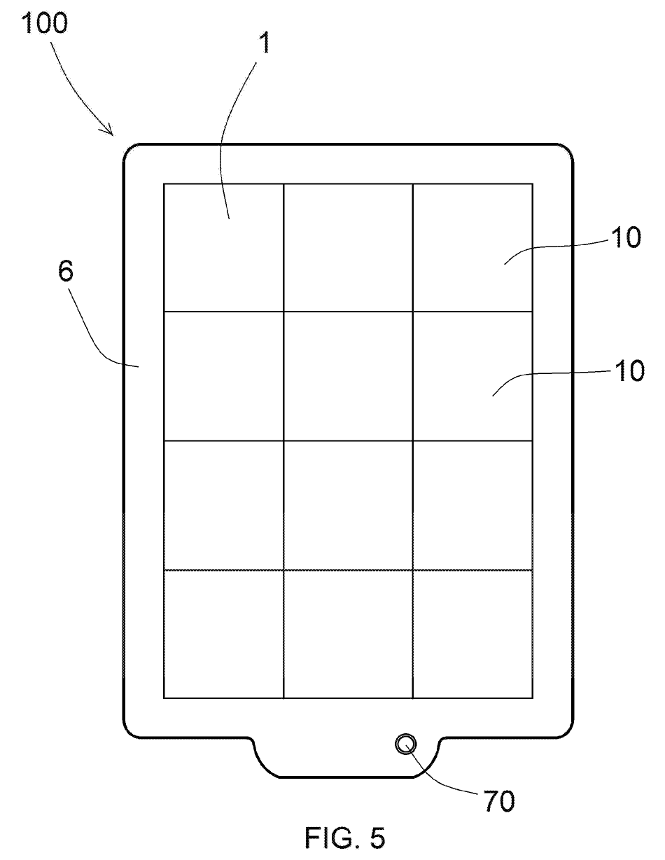

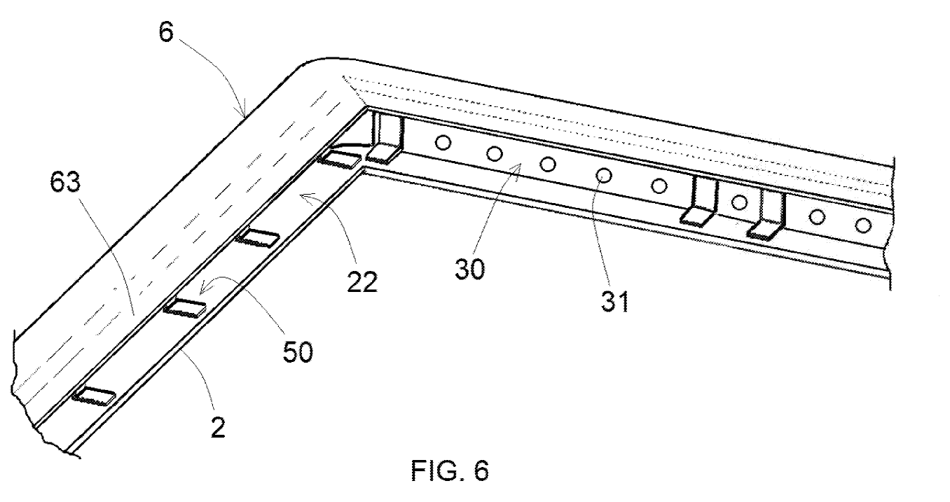

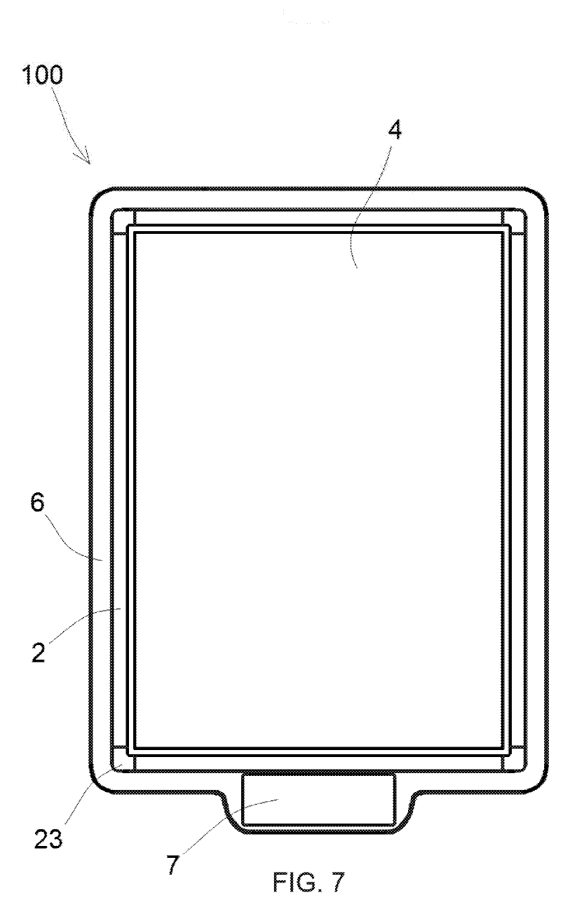

With reference to FIGS. 1, 3, 5, 6, and 7, the cover has a rectangular frame shape with an L-shaped seat (60) in cross-section, comprising a first wing (63) and a second wing (64). The seat (60) of the cover accommodates the flange (21) of the frame, so that the flange (21) of the frame abuts against the first wing (63) of the seat (60) of the cover. Therefore the cover (6) is open inwards so as not to cover the RGB LED strip (30), allowing the light emitted by the LEDs (31) to be diffused towards the inside of the frame (2) onto the puzzle (1) supported by the support (4) that is fixed to the frame (2).

The seat (60) of the cover has a box-shaped enlarged portion (61) to accommodate the power supply (7).

The enlarged portion (61) of the seat of the cover communicates with a hole (62) of the cover. In this way, the button (70) of the power supply passes through the hole (62) of the cover and protrudes externally from the cover in order to be operated by a user.

The assembly and operation of the kit (100) are described below.

The kit (100) comprises the pieces (10), the frame (2), the light source (3), the support (4), the fastening means (5), and the cover (6).

The user assembles the puzzle (1) by fitting the pieces (10) together. Then the user places the puzzle (1) on the support (4). If necessary, a layer of glue can be applied to the support (4) to make the puzzle (1) adhere. In such a case, the glue may be comprised in the kit (100).

Now the corner portions (40) of the support are inserted into the slots (23) of the frame in order to secure the support (4) to the frame (2).

Then the RGB LED strip (30) is disposed in the housing (22) of the frame, possibly gluing the adhesive back side (33) of the LED strip to the housing (22) of the frame.

Successively, the fastening means (5) are applied to the frame (2) in order to secure the LED strip (30) to the frame and the puzzle (1) to the support (4).

Finally, the cover (6) is disposed on the frame (2) so as to cover the frame (2), the fastening means (5), and the LED strip (30).

Evidently, the user must activate the power supply (7) by inserting the batteries into the power supply or connecting the power supply (7) to the mains.

Once the kit (100) has been assembled, the user can press the button (70) to choose one of four possible display modes:

in the first mode, the RGB LED strip (30) emits a red light and the first image (I1) is displayed on the puzzle (1);

in a second mode, the RGB LED strip (30) emits a green light and the second image (I2) is displayed on the puzzle (1);

in a third mode, the RGB LED strip (30) emits a blue light and the third image (I3) is displayed on the puzzle (1); and

in a fourth mode, the RGB LED strip (30) alternately emits a red, green, and blue light, respectively, for a preset time, for example 2-6 minutes, and then the first image (I1), the second image (I2), and the third image (I3) are displayed sequentially on the puzzle.

Numerous variations and detailed modifications can be made to the present embodiment of the invention, within the reach of a person skilled in the art, however falling within the scope of the invention as expressed by the appended claims.

1. A kit comprising:
a puzzle comprising a plurality of interlocking pieces;
a frame suitable for supporting the puzzle; and
a light source mounted in the frame and suitable for emitting a red, green and blue light;
wherein the pieces of the puzzle are obtained by cutting a die-cut whereon a first image of red color, a second image of green color, and a third image of blue color are printed; wherein the three images are different and superimposed one on top of the other;
wherein the colors of the three images are such that:
if the die-cut is illuminated with a red light, only the first image is visible and the second and third images are not visible;
if the die-cut is illuminated with a green light, only the second image is visible and the first and third images are not visible;
if the die-cut is illuminated with a blue light, only the third image is visible and the first and second images are not visible.

2. The kit of claim 1, wherein the light source comprises an RGB LED strip comprising a plurality of LEDs suitably configured to emit a red, green, and blue light, and the frame comprises a housing suitable for accommodating said RGB LED strip.

3. The kit of claim 2, wherein the RGB LED strip comprises 50-70 LEDs.

4. The kit of claim 2, wherein the RGB LED strip has a length equal to the perimeter of the frame in such a way that the RGB LED strip is bent like a rectangular element and is inserted into the housing of the frame.

5. The kit of claim 2, wherein the RGB LED strip comprises a front side whereon the LEDs are mounted, and an adhesive back side in such a way to adhere to the housing of the frame.

6. The kit of claim 1, wherein said kit comprises an electrical power supply suitable for electrically powering said light source.

7. The kit of claim 6, wherein the electrical power supply comprises batteries and/or an electrical connector for connection to an electrical mains.

8. The kit of claim 6, wherein the electrical power supply comprises a button operable by the user.

9. The kit of claim 8, wherein the button is configured to be operated by the user to enable four possible lighting modes:
a first mode, wherein the LEDs are continuously powered to emit a red light;
a second mode, wherein the LEDs are continuously powered to emit a green light;
a third mode, wherein the LEDs are continuously powered to emit a blue light; and
a fourth mode, wherein the LEDs are powered to alternately emit a red, green and blue light for a preset time, respectively.

10. The kit of claim 2, wherein said kit comprises a support suitable for supporting said puzzle; the support having a planar shape with four corner portions suitable for being inserted into slots formed at the corners between the side walls of the frame.

11. The kit of claim 10, wherein said kit comprises fastening means comprising clips suitable for retaining the LED strip in the housing of the frame and compressing the puzzle on the support that is attached to the frame.

12. The kit of claim 1, wherein said kit comprises a cover having the shape of a rectangular frame with a seat with an L-shaped section, suitable for accommodating the frame, so that the light source is not covered and can emit light onto the puzzle.
